(19) United States
(12) Patent Application Publication
(10) Pub. No.: US 2015/0361645 A1
(43) Pub. Date: Dec. 17, 2015

(54) DEVICE FOR THE INTRODUCTION OF SOAP INTO A WATER SUPPLY

(71) Applicant: Michael F. Bonacci, Brooklyn, NY (US)

(72) Inventors: Michael F. Bonacci, Brooklyn, NY (US); William J. DiNoia, Levittown, NY (US); Brian Aubin, Bay Shore, NY (US)

(21) Appl. No.: 14/735,703

(22) Filed: Jun. 10, 2015

Related U.S. Application Data
(60) Provisional application No. 62/011,121, filed on Jun. 12, 2014.

(51) Int. Cl. E03C 1/046; B01F 3/08; B01F 15/02; E03C 1/04

(52) U.S. Cl. CPC E03C 1/046; E03C 1/0408; B01F 3/08; B01F 15/0247

(57) ABSTRACT

A device for introducing soap into a high pressure water circuit includes a soap reservoir, a mixing chamber and a pump. A water supply line in fluid communication with a water source and the mixing chamber provides unmixed water to the device. The pump is in fluid communication with the soap reservoir and the mixing chamber and selectively transfers a desired volume of soap from the soap reservoir into the mixing chamber. A mixing valve that is selectively adjustable by a user controls the proportion of the soap and water mixture exiting the device for use. A housing adjustably mounts the device in a shower so that the relative height of the device in a shower may be adjusted. An output supply line in fluid communication with mixing chamber and a nozzle allows a mixture of water and soap to exit the device for use.

### CROSS REFERENCE TO RELATED APPLICATIONS

This application is related to U.S. Provisional Application Ser. No. 62/011,121, filed on Jun. 12, 2014, and entitled “Device For The Introduction Of Soap Into The Water Supply Of A Shower By Means Of An Adjustable Housing”, the disclosure of which is incorporated herein by reference and on which priority is hereby claimed.

### BACKGROUND OF THE INVENTION

1. Field of the Invention

This invention generally relates to shower devices, and more particularly relates to devices that introduce soap into the water supply of a shower.

2. Description of the Prior Art

There are devices that have been designed to introduce soap into the water supply of a shower and which operate on the venturi principal (see U.S. Pat. No. 4,998,836 for example). By this principal, the water upstream of the shower head is forced through a convergent/divergent duct (venturi). At or near the narrowest point of this duct, soap is drawn into the water supply by the pressure differential resulting from the high local flow velocity of the water. Alternate designs utilize back pressure from a line constriction to force water into the soap holding tank which mixes the entire volume together (see U.S. Pat. No. 5,333,789 for example). In addition, several methods of injecting soap into the water stream via a pump have been devised (see U.S. Pat. No. 8,662,418 for example).

Due to water conservation mandates in the late 20^{th} century, many governments have required the use of restricted flow shower heads. The large backpressures created by the introduction of shower heads with flow restricting features has rendered the venturi based soap introduction methods inadequate or obsolete (due to the high backpressure of these restricted flow showerheads, a positive pressure gradient to promote the flow of soap can no longer be created by increasing localized water flow without a significant reduction in overall shower performance). The second method, by which soap is mixed under pressure in the soap container, does not allow for the accurate control of soap introduction into the water stream—the constant mixing and dilution of the entire volume of soap by the incoming water stream creates a diminishing concentration of soap and would require a refill after every use to arrive at a reliable and consistent proportion of soap to water. The third option of pumping the soap directly via electrical or manual means is desirable; however, most concepts do not offer the mechanical advantage necessary to develop the soap pressures up to 50-70 psi, pressures necessary to overcome the possible line back pressures caused by modern flow restricting shower heads.

In addition to the difficulties overcoming the hydraulic aspects of soap introduction, the proximity in these designs of the soap reservoir to the shower head results in a very high elevation of the soap reservoir. The location of this reservoir high in the shower stall, and any valves required to control the mixing of soap, may be difficult for some users to reach—especially those with handicaps and/or limited mobility. Many of the users who require soap in the shower stream may require single handed control of the soap release and mixing system at a height that is consistent with a user seated in a chair or wheelchair.

### OBJECTS AND SUMMARY OF THE INVENTION

It is an object of the present invention to provide an improved device for introducing soap into a high pressure water circuit of restricted shower flow devices.

This invention overcomes the difficulties of introducing soap into the high pressure water circuit of restricted shower flow devices through the application of a high-mechanical-advantage plunger pump. This pump, integrally located into a housing with a soap reservoir, is actuated by the user with a “syringe” style button and grip which transmits the user's force and displacement through a force multiplying “bell crank” mechanism. By this mechanism, a precise volume of soap under high pressure can be delivered to the shower feed water. This system also allows for the judicious metering of soap into a mixing chamber by allowing the operator to count the button displacements, and therefore the exact quantity of soap required; this is in contrast to the continuous mix devices where the precise proportioning of soap and water is not achievable. In parallel with the soap dispensing and mixing mechanism, a three way mixing valve allows the user to control the proportion of water to be mixed with soap in the mixing chamber. This feature allows the user to fully bypass the incoming water around the soap mixing chamber, fully mix the incoming flow of water with the soap or any degree of mixing in between.

The soap reservoir, pump and mixing manifold are co-located inside a housing that is adjustable in elevation. This allows for easy access to the soap reservoir for filling, monitoring of the soap level (via a sight window) and allows the user to adjust the height of the soap dispensing button and mixing valve. The housing mounts to a hanging caddy, on which it can slide vertically; set screws are used to lock the housing at the desired height. When used in conjunction with a wand type shower head, a specialized bracket at the front of the housing provides the user an alternate and adjustable shower position. This permits a lower shower head height than would otherwise be possible and may assist wheelchair bound or seated individuals in gaining access to the shower wand.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a perspective view of a soap dispenser system formed in accordance with the present invention.

FIG. 2 is a perspective view of the soap dispenser system of the present invention shown in FIG. 1 and illustrating how the soap dispenser system is adjustable in vertical height.

FIG. 3 is a side view of the soap dispenser system of the present invention shown installed in a shower and positioned relative to a person standing therein.

FIG. 4 is a side view of the soap dispenser system of the present invention shown installed in a shower and positioned relative to a person in a sitting position therein.

FIG. 5 is a transverse partial cross-sectional view through the center of the soap dispenser system of the present invention and illustrating the components thereof.

FIG. 6 is a longitudinal partial cross-sectional view of the soap dispenser system of the present invention and illustrating certain components thereof.

FIG. 7A is an enlarged cross-sectional view of a portion of the soap dispenser system of the present invention shown encircled in FIG. 5 and illustrating the passage of a mixture of soap and water through the dispenser system and to an outlet port.

FIG. 7B is an enlarged cross-sectional view of a portion of the soap dispenser system of the present invention shown encircled in FIG. 5 and illustrating the non-passage of the mixture of soap and water through the dispenser system and only water being supplied to the outlet port.

FIG. 8 is a schematic diagram of the flow of water and soap through the soap dispenser system of the present invention.

FIG. 9 is a block diagram/part sectional view of certain components of the soap dispenser system formed in accordance with an alternative version of the present invention.

FIG. 10 is a chart containing a detailed parts list for the components of the soap dispenser system of the present invention shown in FIG. 9.

### DETAILED DESCRIPTION OF THE PREFERRED EMBODIMENTS

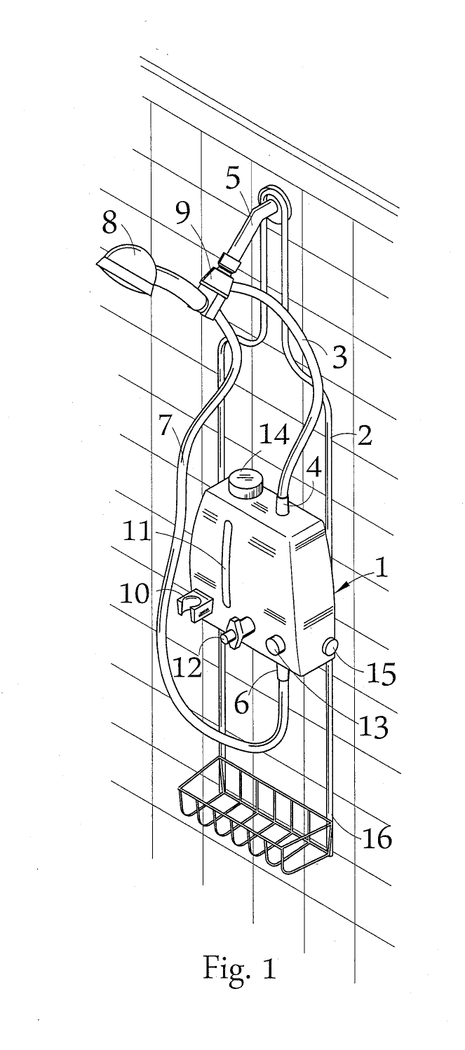

FIG. 1 shows the dispenser system main housing assembly 1 adjustably mounted on the hanging shower caddy 2, which is located on the pipe stem of a conventional shower water supply pipe 5. This housing is connected to the supply line 3 of a wand type shower system via fitting 4. Supply line 3 is connected at its other end to the combination shower handle bracket and fluid fitting 9 at the head of supply pipe 5. After the supply water arrives at housing 1 and is mixed with soap, the mixed solution is discharged from the housing at fitting 6 and carried to the wand style shower handle 8 via hose 7. In FIG. 1, the shower handle is hung conventionally on bracket 9 but can also be affixed to housing 1 via the forked bracket 10 at the housing front. The front of the main housing 1 features a soap level sight window 11, a soap pump plunger 12, and a mixture control knob 13. The screw type lid 14 covers and seals the soap reservoir 19 and allows the user internal access for the refilling of the reservoir. Set screw 15 at the nearside of the housing (and a corresponding far side setscrew 22, not visible in FIG. 1) allows the user to lock the vertical position of the main housing 1 on the rails of the shower caddy 2. The lower end of the caddy has an integral basket 16 to hold toiletries.

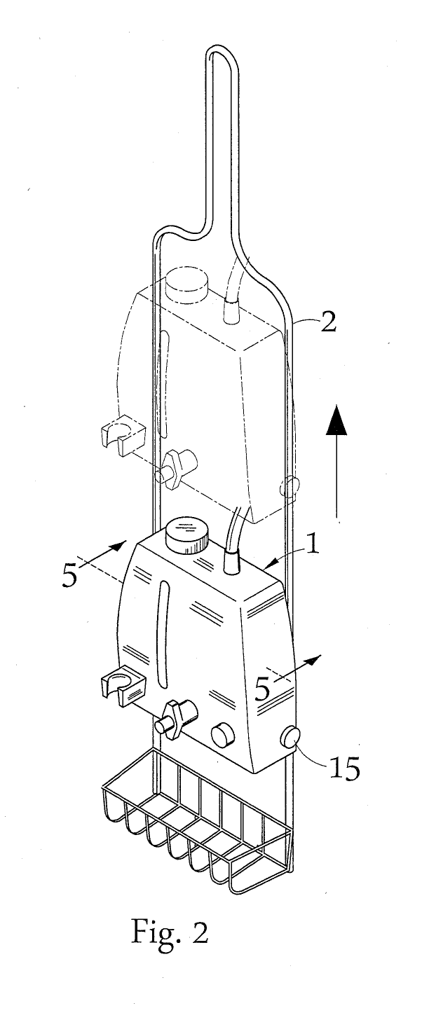

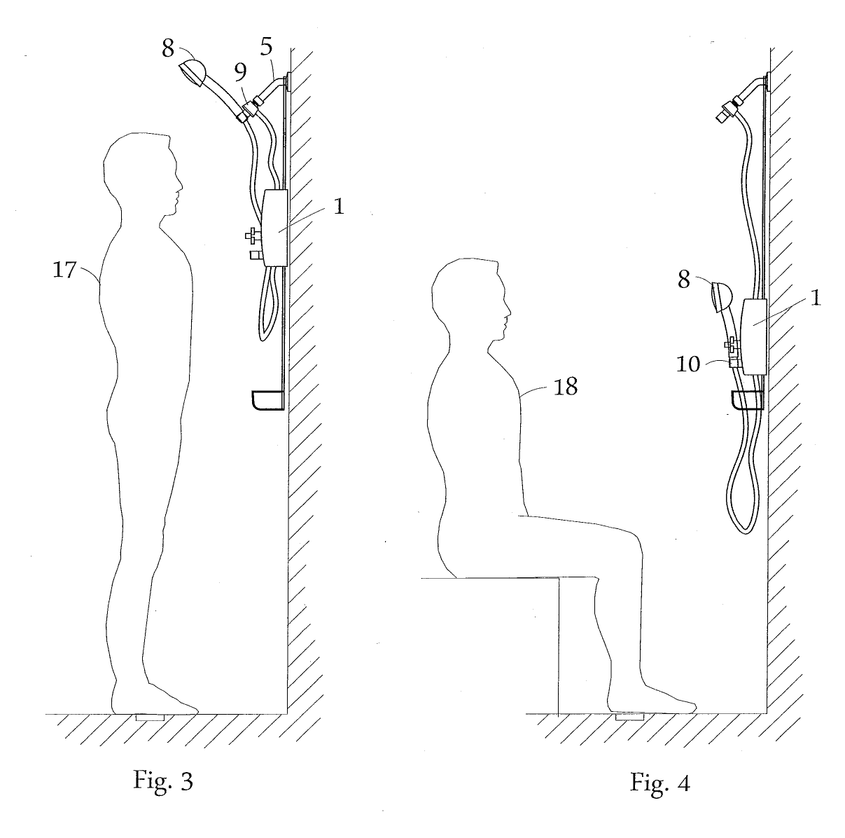

FIG. 2 shows the range of adjustability for users that may have limited mobility (hoses 3 and 7 have been partially omitted for clarity); the dispenser system housing 1 may be raised, as indicated by the vertical arrow, and lowered on the caddy 2 by setscrews 15 and 22 (not shown). In the case of the standing user 17 of FIG. 3, the housing 1 is in its raised position with the shower handle 8 hung conventionally on bracket 9 which is mounted to shower stem 5. FIG. 4 shows a seated individual 18 with housing 1 is in lowest position. In this lowered position, shower handle 8 is hung on bracket 10 which is an integral part of soap dispensing housing 1.

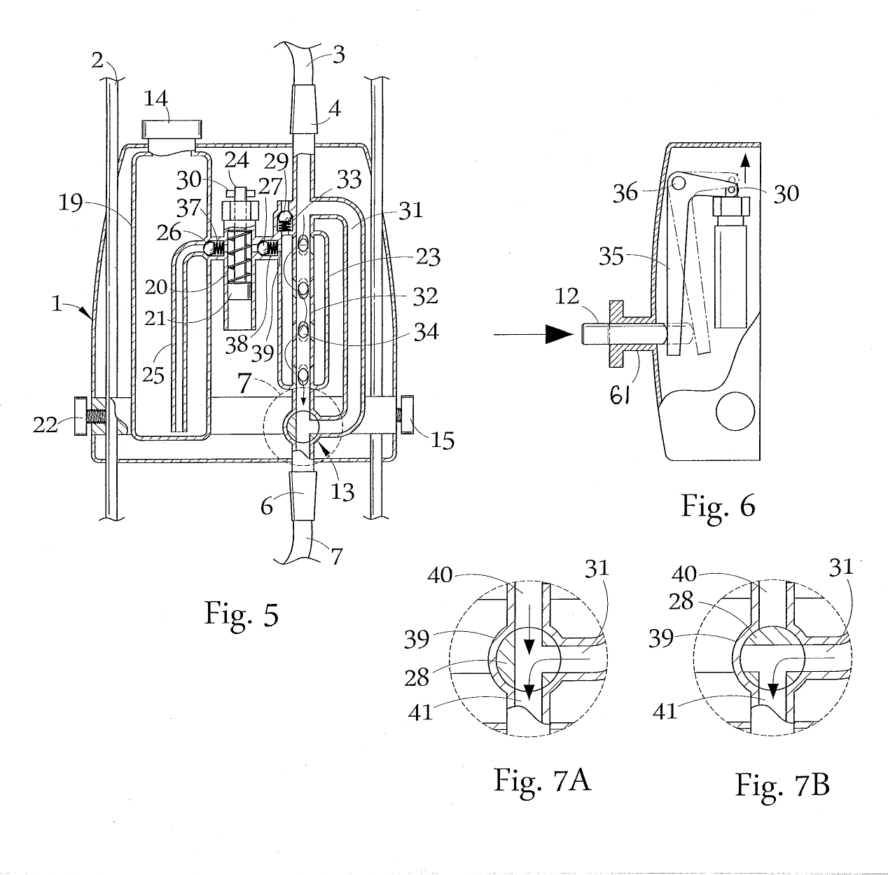

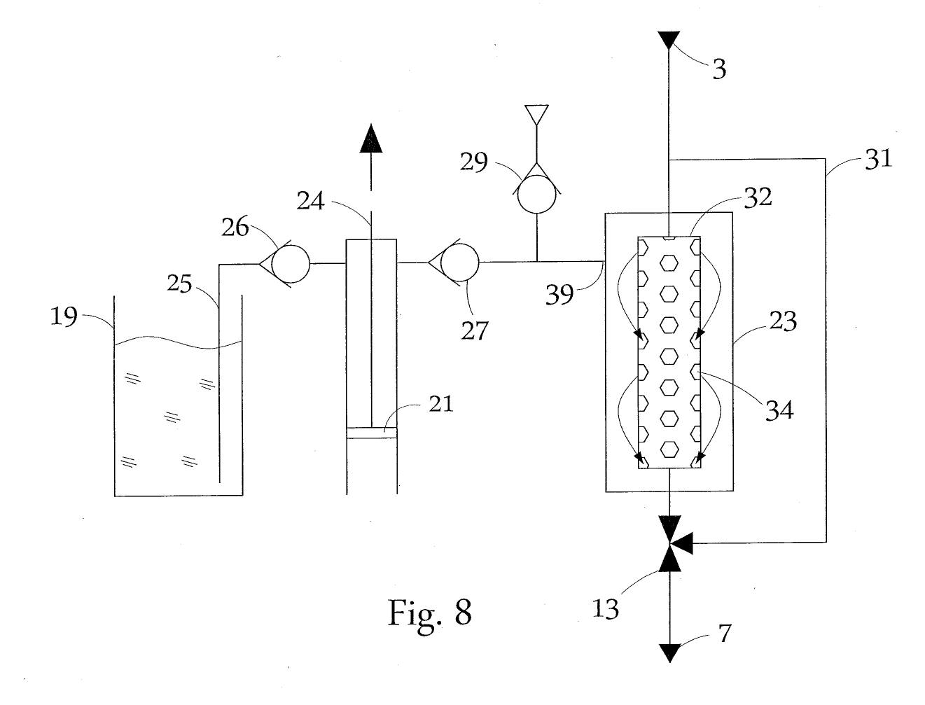

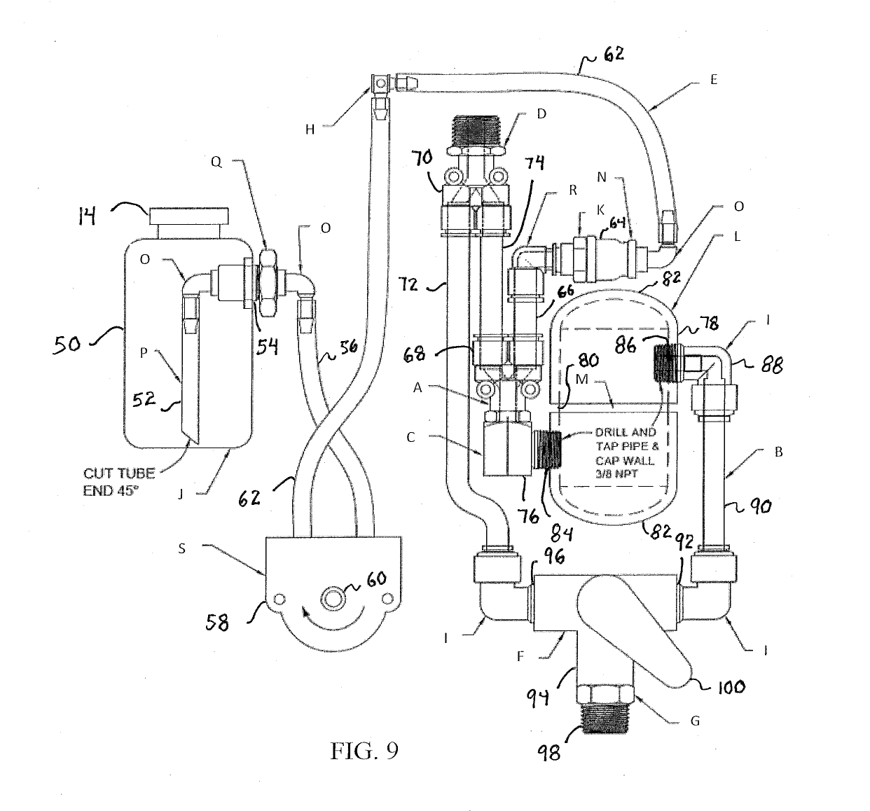

FIG. 5 shows a partial section of the main housing 1 revealing the manifold of subcomponents located within the main housing shell. In this figure, a portion of the caddy 2 can be seen as well as the set screws 22 and 15 which lock the vertical position of housing 1 on the caddy. As a reference, the schematic representation of this manifold assembly can be seen in FIG. 8. The reservoir 19 for the soap and its lid 14 serve as a vessel for soap storage until pumped into the mixing chamber 23 by the piston 21 affixed to rod 24. The displacement of the piston 21 by the user drives the soap past a backflow preventing check valve 27 and against the pressure of the water supply. By the return action of piston 21, under the influence of spring 20, a volume of soap is drawn up tube 25 out of the reservoir 19 though a backflow preventing check valve 26; this action primes the system for the next pump actuation. Both check valves 26 and 27 are ball type and have preload springs, 37 and 38 respectively, to ensure the positive seating of these valves regardless of housing orientation or soap viscosity. The soap from port 39 (i.e., the outlet port of the pump, downstream of the check valve 27) and the inflowing water from fitting 4 combine in a mixing chamber 23. Within chamber 23 is a perforated mixing baffle 32 concentrically located. This baffle features obliquely drilled holes 34 in an alternating pattern which promote the inflow and outflow of water with respect the baffle centerline (this water action is represented by the downward sinuous arrow in FIG. 5) to maximize soap and water mixing. The proportion of soap mixed water from chamber 23 to unmixed water, contained within bypass tube 31 (which is in fluid communication with supply line 3 and mixing valve assembly 13) is controlled by the 3-way mixing valve assembly 13 consisting of a rotating 28 and stationary 39 ported element. The rotating element 28 of this valve 13 has three connected flow passages, at 0, 90 and 180 degrees with respect to each other. When the rotating element 28 is turned such that all three flow passages of valve assembly 13 are in fluid communication as is shown in FIG. 7A, the largest proportion of soap and water mixture can be passed to valve outlet passage 41. When the rotating element 28 is turned to close off inlet flow passage 40 connected to the outlet of mixing chamber 23 but allowing fluid communication between the valve inlet passage connected to bypass tube 31 and valve outlet passage 41, as is shown in FIG. 7B, the soap and water mixture from inlet passage 40 is blocked from flowing to outlet passage 41 and it is the unmixed supply water from bypass tube 31 that is fed to outlet port 41. Depending on the user's setting of valve 13, the final mix of water and soap or unmixed water is delivered to fitting 6 and on to the user as previously described. When the water supply is interrupted to water supply pipe 5, the entrained water in hoses 3 and 7 may create a suction condition at the mixing chamber 23; this could result in the unwanted flow of soap from reservoir 19 into the mixing chamber. To prevent this, check valve 29 situated in the containment wall of mixing chamber 23 opens when the manifold pressure within chamber 23 is less than atmospheric. Thus, ambient air is admitted to mixing chamber 23 via check valve 29 which increases the manifold pressure internal to mixing chamber 23, preventing the backflow of soap. The positive seating of check valve 29 is maintained by spring 33.

The mechanical action providing the motive force for rodded piston 24 can be seen in FIG. 6. This partial section shows the action of the soap dispensing button and plunger 12 operated by the thumb when the middle and forefinger grasps handle 61. When depressed, as illustrated by the horizontal arrow in FIG. 6, the plunger 12 displaces a bell crank 35, which is constrained by pin 36. This action causes the bell crank 35 to rotate about pin 36, resulting in the displacement of pin 30 which is connected in a trunnion fashion to a rod at the free end of which is attached piston 24. This motion, imparted to piston 24, indicated by the vertical arrow in FIG. 6, displaces a volume of soap into the mixing chamber 23 inside the manifold as previously described.

The present invention for introducing soap into a water supply will now be further described.

In accordance with one form of the present invention, a device for the introduction of soap into a water supply includes a soap reservoir 19 for holding a volume of liquid soap, the soap reservoir 19 having a soap outlet, and a soap and water mixing chamber 23. The soap and water mixing chamber 23 has a soap inlet for receiving soap therethrough, a water inlet for receiving water therethrough and a mixed soap and water outlet. The soap and water mixing chamber 23 causes soap and water received through the soap inlet and the water inlet to be mixed to provide mixed soap and water. The mixed soap and water is discharged from the soap and water mixing chamber 23 through the mixed soap and water outlet thereof.

The device further includes a water supply line 3 having a first end and a second end disposed opposite the first end. The first end of the water supply line 3 is in fluid communication with the water inlet of the soap and water mixing chamber 23. The second end of the water supply line 3 is in fluid communication with a water source 5.

The device also includes a mixed soap and water output supply line 7. The mixed soap and water output supply line 7 has a first end and a second end disposed opposite the first end. The first end of the mixed soap and water output supply line is in fluid communication with the mixed soap and water outlet of the soap and water mixing chamber 23.

The device further includes a pump. The pump is in fluid communication with the soap outlet of the soap reservoir 19 and the soap inlet of the soap and water mixing chamber 23. The pump is operable by a user to transfer soap from the soap reservoir 19 to the soap and water mixing chamber 23.

Preferably, the soap and water mixing chamber 23 includes a perforated mixing baffle 32 situated therein. The mixing baffle 32 is preferably in the form of an elongated tube having a sidewall and defining an inner bore and having a plurality of openings 34 formed through the sidewall of the elongated tube and in fluid communication with the inner bore and through which soap and water within the mixing chamber 23 may flow. The elongated tube of the mixing baffle 32 has a first open end in fluid communication with the water inlet of the soap and water mixing chamber 23 and a second open end situated axially opposite the first open end and being in fluid communication with the mixed soap and water outlet of the mixing chamber 23. Preferably, the second open end of the elongated tube of the mixing baffle 32 defines the mixed soap and water outlet of the mixing chamber 23. The openings 34 formed in the elongated tube of the mixing baffle are spaced apart from each other along at least a portion of the axial length of the elongated tube.

The device of the present invention may also include a bypass conduit 31. The bypass conduit 31 has a first open end which is in fluid communication with the water supply line 3, and a second open end situated opposite the first open end. The bypass conduit 31 allows a flow of water to pass therethrough.

Along with the bypass conduit 31, the device includes a mixing valve 13. The mixing valve 13 has a first inlet 40, a second inlet and an outlet 41. The first inlet 40 of the mixing valve 13 is in fluid communication with the mixed soap and water outlet of the soap and water mixing chamber 23. The second inlet of the mixing valve 13 is in fluid communication with the second open end of the bypass conduit 31, and the outlet 41 of the mixing valve 13 is in fluid communication with the mixed soap and water output supply line 7. The mixing valve 13 is selectively adjustable to control and proportion the flow of mixed soap and water from the soap and water mixing chamber 23 flowing through the mixed soap and water outlet thereof and provided to the mixed soap and water output supply line 7 and the flow of water passing through the second open end of the bypass conduit 31 and provided to the mixed soap and water output supply line 7.

More specifically, the mixing valve 13 includes a movable element 28. The movable element 28 is positionable between at least a first position in which each of the first inlet 40 of the mixing valve 13, the second inlet of the mixing valve 13 and the outlet 41 of the mixing valve 13 is open such that both mixed soap and water flowing through the mixed soap and water outlet of the mixing chamber 23 and water flowing through the second open end of the bypass conduit 31 are provided to the mixed soap and water output supply line 7, and at least a second position in which the first inlet 40 of the mixing valve 13 is closed, the second inlet of the mixing valve 13 is open and the outlet 41 of the mixing valve 13 is open such that only water flowing through the second open end of the bypass conduit 31 is provided to the mixed soap and water output supply line 7. Even more preferably, the movable element 28 of the mixing valve 13 is positionable in selectable positions between the first position and the second position to proportion the amount of flow of mixed soap and water from the soap and water mixing chamber 23 and the flow of water from the bypass conduit 31 being provided to the mixed soap and water output supply line 7.

The pump of the device of the present invention includes a pump inlet and a pump outlet, as well as a first check valve 26 interconnected between the pump inlet and the soap outlet of the soap reservoir 19, and a second check valve 27 interconnected between the pump outlet and the soap inlet of the soap and water mixing chamber 23. The first check valve 26 prevents the backflow of fluid from the pump into the soap reservoir 19, and the second check valve 27 prevents the backflow of fluid from the soap and water mixing chamber 23 into the pump.

Preferably, the pump includes a cylinder defining an inner bore, a piston 24 movable axially within the inner bore of the cylinder, a rod having a first end and a second end situated axially opposite the first end, the piston being attachable to the second end of the piston rod, and a bell crank linkage 35, the bell crank linkage 35 being coupled to the first end of the piston rod. The bell crank linkage 35 is pivotable about a pivot point 36 to cause the piston 24 within the cylinder to move between a first position and a second position. When the piston 24 moves from the first position to the second position, the piston 24 causes soap contained within the inner bore of the pump cylinder to be forced therefrom and through the pump outlet and into the soap inlet of the soap and water mixing chamber 23. When the piston 24 moves from the second position to the first position, the piston 24 causes soap to be drawn into the inner bore of the cylinder through the pump inlet and from the soap outlet of the soap reservoir 19.

As mentioned previously, the device of the present invention for the introduction of soap into a water supply includes a housing 1. The housing 1 defines an interior cavity. Each of the soap reservoir 19, the soap and water mixing chamber 23, the pump and the bell crank linkage 35 is disposed within the interior cavity of the housing 1. The housing 1 includes a front wall, which has an elongated vertical slot 11 formed through the thickness thereof. The elongated slot 11 is situated on the front wall of the housing 1 to be in alignment with the soap reservoir 19 disposed in the interior cavity of the housing 1. Preferably, the soap reservoir 19 is formed from a non-opaque material such that a level of any liquid soap contained by the soap reservoir 19 is viewable through the reservoir material and through the elongated slot 11 formed in the front wall of the housing 1.

The housing 1 includes an outer wall, which may be the front wall. The device also preferably includes a push button pump actuator that is mounted on the outer wall of the housing 1 and is accessible to a user of the device. The push button pump actuator is operatively linked to the bell crank linkage 35 to effect pivotal movement of the bell crank linkage 35.

More specifically, and more preferably, the push button pump actuator includes a grasping flange 61. The grasping flange 61 is mounted on the outer wall of the housing 1 and extends outwardly therefrom. The grasping flange 61 has a bore formed therethrough, and a push button rod 12. The push button rod 12 is mounted in the bore of the grasping flange 61 and is reciprocatingly movable therein. The push button rod 12 has a first axial end extending outwardly from the grasping flange 61 and which is exposed such that the exposed first end may be pushed by the user of the device, and a second axial end situated opposite the first axial end. The second axial end engages the bell crank linkage 35 to effect pivotal movement thereof when the exposed first end of the rod 12 is pushed by the user of the device.

The device also preferably includes a hanging shower caddy 2. The housing is mounted on the hanging shower caddy 2 and hangs therefrom.

In one form, the hanging shower caddy 2 includes a pair of spaced apart, parallel rails, each rail of the pair of rails having a first end and a second end situated opposite the first end. The first ends of the rails are joined together to form a loop such that the loop may be positioned on a water supply pipe 5 extending outwardly from a shower wall and be supported thereby. The housing 1 is mounted on the rails of the hanging shower caddy 2. Preferably, the housing 1 is movably positionable along at least a portion of the axial length of each rail of the pair of rails of the hanging shower caddy 2.

In a preferred form of the present invention, the hanging shower caddy 2 of the device further includes a basket 16 mounted to the rails of the pair of rails in proximity to the second axial end thereof, the basket 16 being provided to hold shower items. Also, the housing 1 preferably includes a forked bracket 10. The forked bracket 10 is mounted on the outer wall of the housing 1, such as the front wall, and extends outwardly therefrom. The forked bracket 10 is provided to removably hold the second end of the mixed soap and water output supply line 7 thereto.

Another version of the soap dispenser system of the present invention is shown in FIG. 9 of the drawings. The various components of the system shown in FIG. 9 are situated within the interior cavity of the housing 1.

More specifically, the soap reservoir 50, which may be clear or translucent, holds liquid soap which will be mixed with water supplied to the dispenser system. A tube 52, having its distal end cut at a 45 degree angle, is situated in the soap reservoir 50 and is used to draw soap therefrom through the tube 52. The soap reservoir 50 has an outlet in the form of a fitting 54 to which the first end of a soap supply tube 56 is connected. The opposite second end of the soap supply tube 56 is connected to the inlet of a pump 58.

The pump 58 in the dispenser system of FIG. 9 differs from that of the previous embodiment shown in FIGS. 5 and 6 in that it is not a piston-type pump and no bell crank linkage or push button pump actuator is included. Rather, the pump 58 in this alternative embodiment of the soap dispenser system is a centrifugal pump having an internal impeller within the pump housing. The impeller is mounted on a shaft which passes through the dispenser housing 1 at the front wall thereof and on the exposed free end of which a knob 60 is secured. The knob 60 is periodically turned by a user of the soap dispenser system in order to effect rotational movement of the impeller within the pump housing. The rotating impeller will draw liquid soap from the reservoir 50 and through the soap supply tube 56 to the pump 58, and out of the pump.

The pump 58 has an outlet to which is connected one end of a pump outlet tube 62. The opposite other end of the pump outlet tube 62 is connected to the inlet of a one-way check valve 64. The outlet of the check valve 64 is connected, through associated piping 66, to a first inlet port of a first Y-fitting 68 used as a fluid combiner.

A water supply line is threaded onto the inlet port of a second Y-fitting 70 used as a fluid splitter. This second Y-fitting 70 splits the water supplied to the dispenser system to a first end of a water bypass tube 72 and to a first end of a water-to-mixer tube 74, the first ends of each of which are respectively connected to first and second outlet ports of the second Y-fitting 70. The opposite second end of the water-to-mixer tube 74 is connected to the second inlet port of the first Y-fitting 68, and the outlet port of the first Y-fitting 68 is connected, through a first 90 degree elbow 76, to the inlet port 84 of a soap and water mixing chamber 78.

The soap and water mixing chamber 78 is preferably formed from a section of drain pipe 80 that is closed at its opposite ends with socket caps 82. The mixing chamber 78 stands vertically in the housing 1 when the dispenser system is installed in a shower stall for use. The inlet port 84 of the mixing chamber 78 is formed in the chamber wall and receives or is coupled to the outlet of the first 90 degree elbow 76, and is situated low on the chamber 78, in proximity to the bottom thereof, and receives both soap from the pump outlet tube 62 and water from the water-to-mixer tube 74, combined by the first Y-fitting 68.

Water and soap received through the inlet port 84 of the mixing chamber 78 are mixed together through turbulent flow therewithin. In this embodiment of the dispenser system, the mixing baffle described previously is not used, although it may be.

The mixing chamber 78 includes an outlet port 86 formed in the chamber wall and situated on the diametrical opposite side of the chamber 78 from where the inlet port 84 is located, and high on the chamber 78, in proximity to the top thereof. The inlet of a second 90 degree elbow 88 is received by or coupled to the outlet port 86. The outlet of this second 90 degree elbow 88 is connected, through a mixed soap and water conduit 90, to a first inlet port 92 of a three-way ball valve 94.

The second end of the water bypass tube 72 is connected to a second inlet port 96 of the three-way ball valve 94, and the mixed soap and water output supply line may be threaded onto the outlet port 98 of the three-way ball valve 94.

A handle 100 of the ball valve 94 is exposed on the front wall of the housing 1 for the user to grasp, and is coupled to a movable element within the valve 94. When the handle 100 is moved to a first position, mixed soap and water from the mixing chamber 78 is cut off by the movable element and only water supplied to the valve 94 from the water bypass tube 72 is provided to the soap and water output supply line. When the handle 100 is moved to a second position, water from the bypass tube 72 is cut off by the movable element and only mixed soap and water from the mixing chamber 78 supplied to the valve 94 is provided to the soap and water output supply line. The handle 100 may be moved to intermediate positions between the first and second positions so that some water from the water bypass tube 72 may be allowed by the valve 94 to flow into the output supply line and some mixed soap and water from the mixing chamber 78 may be allowed by the valve 94 to flow into the output supply line. Thus, the user may adjust and proportion the amount of water and mixed soap and water he or she receives through the mixed soap and water output supply line and to the shower wand attached thereto by selecting various positions of the valve handle 100.

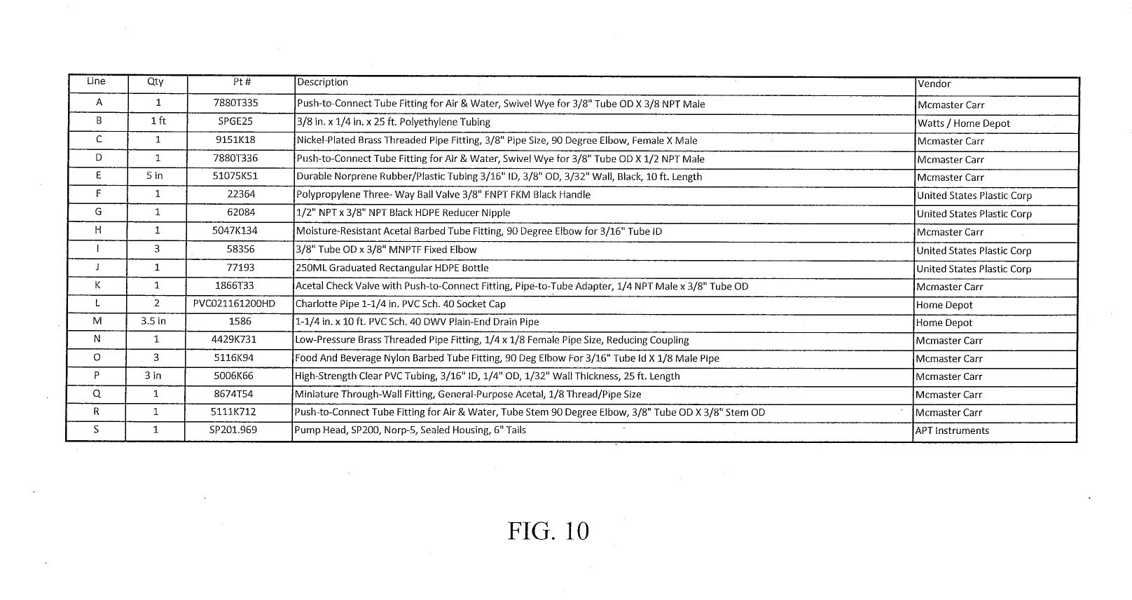

A chart which provides a preferred detailed parts list for the components of the soap dispenser system of the present invention shown in FIG. 9 and described above is shown in FIG. 10. Reference letters used in the chart indicating the various parts listed therein are shown in FIG. 9 and provided to avoid confusion with the reference numbers shown in the drawings.

A list of possible applications for the soap dispenser system of the present invention includes hotel and residential showers to mitigate the over consumption of soap or for general showering convenience; hospital and rehabilitation center showers for persons with limited strength and mobility; application of topical medication in human or veterinary medicine; campsite or gymnasium showers where bar soap is not provided; and residential or household installation.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A device for the introduction of soap into a water supply, which comprises:
a soap reservoir for holding a volume of liquid soap, the soap reservoir having a soap outlet;
a soap and water mixing chamber, the soap and water mixing chamber having a soap inlet for receiving soap therethrough, a water inlet for receiving water therethrough and a mixed soap and water outlet, the soap and water mixing chamber causing soap and water received through the soap inlet and the water inlet to be mixed to provide mixed soap and water, the mixed soap and water being discharged from the soap and water mixing chamber through the mixed soap and water outlet thereof;
a water supply line having a first end and a second end disposed opposite the first end, the first end of the water supply line being in fluid communication with the water inlet of the soap and water mixing chamber, the second end of the water supply line being in fluid communication with a water source;
a mixed soap and water output supply line, the mixed soap and water output supply line having a first end and a second end disposed opposite the first end, the first end of the mixed soap and water output supply line being in fluid communication with the mixed soap and water outlet of the soap and water mixing chamber; and
a pump, the pump being in fluid communication with the soap outlet of the soap reservoir and the soap inlet of the soap and water mixing chamber, the pump being operable by a user to transfer soap from the soap reservoir to the soap and water mixing chamber.

2. A device for the introduction of soap into a water supply as defined by claim 1, wherein the soap and water mixing chamber includes a perforated mixing baffle situated therein, the mixing baffle being in the form of an elongated tube having a sidewall and defining an inner bore and having a plurality of openings formed through the sidewall of the elongated tube and in fluid communication with the inner bore and through which soap and water within the mixing chamber may flow, the elongated tube of the mixing baffle having a first open end in fluid communication with the water inlet of the soap and water mixing chamber and a second open end situated axially opposite the first open end and being in fluid communication with the mixed soap and water outlet of the mixing chamber.

3. A device for the introduction of soap into a water supply as defined by claim 2, wherein the second open end of the elongated tube of the mixing baffle defines the mixed soap and water outlet of the mixing chamber.

4. A device for the introduction of soap into a water supply as defined by claim 2, wherein the openings formed in the elongated tube of the mixing baffle are spaced apart from each other along at least a portion of the axial length of the elongated tube.

5. A device for the introduction of soap into a water supply as defined by claim 1, which further comprises:
a bypass conduit, the bypass conduit having a first open end which is in fluid communication with the water supply line, and a second open end situated opposite the first open end, the bypass conduit allowing a flow of water to pass therethrough; and
a mixing valve, the mixing valve having a first inlet, a second inlet and an outlet, the first inlet of the mixing valve being in fluid communication with the mixed soap and water outlet of the soap and water mixing chamber, the second inlet of the mixing valve being in fluid communication with the second open end of the bypass conduit, and the outlet of the mixing valve being in fluid communication with the mixed soap and water output supply line, the mixing valve being selectively adjustable to control and proportion the flow of mixed soap and water from the soap and water mixing chamber flowing through the mixed soap and water outlet thereof and provided to the mixed soap and water output supply line and the flow of water passing through the second open end of the bypass conduit and provided to the mixed soap and water output supply line.

6. A device for the introduction of soap into a water supply as defined by claim 5, wherein the mixing valve includes a movable element, the movable element being positionable between at least a first position in which each of the first inlet of the mixing valve, the second inlet of the mixing valve and the outlet of the mixing valve is open such that both mixed soap and water flowing through the mixed soap and water outlet of the mixing chamber and water flowing through the second open end of the bypass conduit are provided to the mixed soap and water output supply line, and at least a second position in which the first inlet of the mixing valve is closed, the second inlet of the mixing valve is open and the outlet of the mixing valve is open such that only water flowing through the second open end of the bypass conduit is provided to the mixed soap and water output supply line.

7. A device for the introduction of soap into a water supply as defined by claim 6, wherein the movable element of the mixing valve is positionable in selectable positions between the first position and the second position to proportion the amount of flow of mixed soap and water from the soap and water mixing chamber and the flow of water from the bypass conduit being provided to the mixed soap and water output supply line.

8. A device for the introduction of soap into a water supply as defined by claim 1, wherein the pump includes a pump inlet and a pump outlet; and
wherein the device further comprises:
a first check valve interconnected between the pump inlet and the soap outlet of the soap reservoir; and
a second check valve interconnected between the pump outlet and the soap inlet of the soap and water mixing chamber;
wherein the first check valve prevents the backflow of fluid from the pump into the soap reservoir; and
wherein the second check valve prevents the backflow of fluid from the soap and water mixing chamber into the pump.

9. A device for the introduction of soap into a water supply as defined by claim 1, wherein the pump includes a cylinder defining an inner bore, a piston movable axially within the inner bore of the cylinder, a rod having a first end and a second end situated axially opposite the first end, the piston being attachable to the second end of the piston rod, and a bell crank linkage, the bell crank linkage being coupled to the first end of the piston rod, the bell crank linkage being pivotable about a pivot point to cause the piston within the cylinder to move between a first position and a second position, wherein, when the piston moves from the first position to the second position, the piston causes soap contained within the inner bore of the pump cylinder to be forced therefrom and through the pump outlet and into the soap inlet of the soap and water mixing chamber, and when the piston moves from the second position to the first position, the piston causes soap to be drawn into the inner bore of the cylinder through the pump inlet and from the soap outlet of the soap reservoir.

10. A device for the introduction of soap into a water supply as defined by claim 9, which further comprises:
a housing, the housing defining an interior cavity, each of the soap reservoir, the soap and water mixing chamber, the pump and the bell crank linkage being disposed within the interior cavity of the housing.

11. A device for the introduction of soap into a water supply as defined by claim 10, wherein the housing includes a front wall, the front wall having an elongated slot formed through the thickness thereof, the elongated slot being situated on the front wall of the housing to be in alignment with the soap reservoir disposed in the interior cavity of the housing; and
wherein the soap reservoir is formed from a non-opaque material such that a level of any liquid soap contained by the soap reservoir is viewable through the reservoir material and through the elongated slot formed in the front wall of the housing.

12. A device for the introduction of soap into a water supply as defined by claim 10, wherein the housing includes an outer wall; and
wherein the device further comprises:
a push button pump actuator, the push button pump actuator being mounted on the outer wall of the housing and being accessible to a user of the device, the push button pump actuator being operatively linked to the bell crank linkage to effect pivotal movement of the bell crank linkage.

13. A device for the introduction of soap into a water supply as defined by claim 12, wherein the push button pump actuator includes a grasping flange, the grasping flange being mounted on the outer wall of the housing and extending outwardly therefrom, the grasping flange having a bore formed therethrough, and a push button rod, the push button rod being mounted in the bore of the grasping flange and being reciprocatingly movable therein, the push button rod having a first axial end extending outwardly from the grasping flange and being exposed such that the exposed first end may be pushed by the user of the device, and a second axial end situated opposite the first axial end, the second axial end engaging the bell crank linkage to effect pivotal movement thereof when the exposed first end of the rod is pushed by the user of the device.

14. A device for the introduction of soap into a water supply as defined by claim 1, which further comprises:
a housing, the housing defining an interior cavity, each of the soap reservoir, the soap and water mixing chamber and the pump being disposed within the interior cavity of the housing, the housing having an outer wall; and
a hanging shower caddy, the housing being mounted on the hanging shower caddy.

15. A device for the introduction of soap into a water supply as defined by claim 14, wherein the hanging shower caddy includes a pair of spaced apart, parallel rails, each rail of the pair of rails having a first end and a second end situated opposite the first end, the first ends of the rails being joined together to form a loop such that the loop may be positioned on a water supply pipe and be supported thereby, the housing being mounted on the rails of the hanging shower caddy.

16. A device for the introduction of soap into a water supply as defined by claim 15, wherein the housing is movably positionable along at least a portion of the axial length of each rail of the pair of rails of the hanging shower caddy.

17. A device for the introduction of soap into a water supply as defined by claim 15, wherein the hanging shower caddy further includes a basket mounted to the rails of the pair of rails in proximity to the second axial end thereof, the basket being provided to hold shower items.

18. A device for the introduction of soap into a water supply as defined by claim 14, wherein the housing includes a forked bracket, the forked bracket being mounted on the outer wall of the housing and extending outwardly therefrom, the forked bracket being provided to removably hold the second end of the mixed soap and water output supply line thereto.

19. A device for the introduction of soap into a water supply as defined by claim 1, wherein the pump is a centrifugal pump.

20. A device for the introduction of soap into a water supply as defined by claim wherein the pump includes a pump inlet and a pump outlet; and
wherein the device further comprises:
a check valve interconnected between the pump outlet and the soap inlet of the soap and water mixing chamber;
wherein the check valve prevents the backflow of fluid from the soap and water mixing chamber into the pump.
